(19) United States
(12) Patent Application Publication
(10) Pub. No.: US 2019/0016471 A1
(43) Pub. Date: Jan. 17, 2019

(54) TURBOFAN ENGINE

(71) Applicant: Rolls-Royce Deutschland Ltd & Co KG, Blankenfelde-Mahlow (DE)

(72) Inventors: Jan LIESER, Eichwalde (DE); Peer BOEHNING, Berlin (DE)

(21) Appl. No.: 16/020,383

(22) Filed: Jun. 27, 2018

(30) Foreign Application Priority Data
Jul. 12, 2017 (DE) 10 2017 115 644.5

(51) Int. Cl. B64D 33/04; F02K 1/40; F02K 3/06

(52) U.S. Cl. CPC B64D 33/04; B64D 27/18; F02K 3/06; F02K 1/40

(57) ABSTRACT

A turbofan engine includes: a core engine, a primary flow channel, a secondary flow channel, a machine axis and a thrust nozzle that is a separate thrust nozzle for the secondary flow channel or an integral thrust nozzle for the primary flow channel and the secondary flow channel, and that has a center line and a nozzle exit surface. The thrust nozzle is tilted with respect to the machine axis while forming an articulation angle that the center line of the thrust nozzle forms with respect to the machine axis at least at the nozzle exit, and the nozzle exit surface of the thrust nozzle is oriented obliquely with respect to the center line of the thrust nozzle while forming an angle of inclination that a normal of the nozzle exit surface forms with respect to the center line of the thrust nozzle.

This application claims priority to German Patent Application DE102017115644.5 filed Jul. 12, 2017, the entirety of which is incorporated by reference herein.

### DESCRIPTION

The invention relates to a turbofan engine according to the generic term of patent claim 1.

Turbofan engines that are attached at a wing are arranged below the wing in such a manner that the hot exit jet that is emitted by a turbofan engine in the takeoff phase does not interact with the fully extended rear wing flaps of the wing (also referred to as “flaps”) during takeoff. In general, this can be achieved by observing a sufficient vertical distance between the turbofan engine and the bottom side of the wing. However, in engines with a large diameter as they are increasingly of interest for achieving a large bypass ratio, the mentioned vertical distance is limited by a minimum distance at which the turbofan engine must be kept from the ground.

It is known from U.S. Pat. No. 6 969 028 B2 and U.S. Pat. No. 8 157 207 B2 to configure the thrust nozzle of a turbofan engine in such a manner that the nozzle exit surface of the thrust nozzle extends obliquely to the machine axis of the turbofan engine.

The present invention is based on the objective of providing a turbofan engine which can be arranged below a wing of an airplane and in which an interaction of the exit jet with the wing flaps can be avoided even in large turbofan engines.

This objective is achieved through a turbofan engine with the features of patent claim 1. Embodiments of the invention are indicated in the subclaims.

Accordingly, what is regarded in the present invention is a turbofan engine that can be arranged below a wing of an airplane, and which comprises: a core engine that comprises a compressor, a combustion chamber and a turbine, a primary flow channel that leads through the core engine, a secondary flow channel that leads past the core engine, and a machine axis of the core engine. Further, the turbofan engine comprises a thrust nozzle. The thrust nozzle can be a separate thrust nozzle for the secondary flow channel or an integral thrust nozzle for the primary flow channel and the secondary flow channel. The thrust nozzle has a center line and a nozzle exit surface.

In the invention, it is provided that the thrust nozzle is tilted with respect to the machine axis while forming an articulation angle that the center line of the thrust nozzle forms with respect to the machine axis at least at the nozzle exit, and that the nozzle exit surface of the thrust nozzle is oriented obliquely with respect to the center line of the thrust nozzle while forming an angle of inclination that a normal of the nozzle exit surface forms with respect to the center line of the thrust nozzle. The articulation angle is also referred to as the “kink” or “kink angle”, and the angle of inclination is also referred to as the “scarf” or “scarf angle”. At that, the tilting of the thrust nozzle for forming an articulation angle is performed perpendicular to the vertical plane.

The invention is based on the idea to influence the exit direction of the exit jet from the thrust nozzle, and thus from the turbofan engine, by means of two measures: for one thing, by tilting the thrust nozzle with respect to the machine axis, so that the center line of the thrust nozzle is no longer identical with the machine axis, and, for another thing, through an oblique orientation of the nozzle exit surface, so that the normal of the nozzle exit surface is no longer identical with the center line of the thrust nozzle.

Through these two measures, which can be combined in a suitable manner, it can be achieved that the resulting vector of the exit jet from the engine during take-off thrust (MTO=maximum takeoff thrust) is not oriented horizontally but obliquely downwards, and that it is displaced vertically downwards, so that the gas flow is guided past the extended wing flaps. Here, the invention makes use of the circumstance that the deflection of the exit jet as it is caused by the angle of inclination depends on the operational state. In contrast, the deflection of the exit jet that is caused by the articulation angle is the same in all operational states. In this manner, it can be achieved that in other operational states than the takeoff, in particular during cruise flight, the resulting vector of the exit jet or the thrust vector extends horizontally or at least is deflected to a lesser degree than during takeoff.

Here, it is provided in one embodiment of the invention that the articulation angle and the angle of inclination have different mathematical signs. In particular, it can be provided that the articulation angle is negative (if the axial direction is the x-direction), with the center line of the thrust nozzle being tilted downwards with respect to the machine axis. In contrast, the angle of inclination is positive (if the axial direction is the x-direction), with the normal of the nozzle exit surface being tilted upwards with respect to the center line of the thrust nozzle. During takeoff, it is primarily the effect of the deflection of the exit jet through the articulation angle that is acting. Due to the downwardly tilted orientation of the thrust nozzle, the exit jet does not extend in the axial direction of the machine axis but is diverted downwards with respect to the machine axis, so that the exit jet is guided past the extended wing flaps of the wing. As the pressure ratio between the nozzle internal pressure and the ambient pressure increases, the effect of the jet deflection due to the angle of inclination becomes increasingly stronger. The jet deflection due to the angle of inclination acts in another direction, i.e. the deflection of the exit jet as caused by the angle of inclination occurs upwards, wherein this effect becomes stronger as the pressure ratio between the nozzle internal pressure and the ambient pressure increases. Here, it can be provided that the two effects exactly cancel each other out in the operational state of cruise flight, so that the thrust vector extends in the axial direction of the machine axis during cruise flight.

The following is noted with respect to the used termini:

In a rotationally symmetrical thrust nozzle, the center line of the thrust nozzle is identical with the rotational axis of the thrust nozzle. However, the thrust nozzle is not necessarily rotationally symmetrical. If the thrust nozzle is not rotationally symmetrical, that line is defined as the center line of the thrust nozzle which forms the center line of the thrust nozzle in a vertical longitudinal section containing the machine axis.

As has already been mentioned, the thrust nozzle can be a separate thrust nozzle for the secondary flow channel or an integral thrust nozzle for the primary flow channel and the secondary flow channel. In the first case, separate (primary and secondary) thrust nozzles are provided for the primary flow channel and the secondary flow channel. At that, the cold jet of the secondary flow channel envelops the hot jet of the primary flow channel, without an internal jet intermixing occurring. This embodiment variant is also referred to as a “short cowl”. Here, the invention regards the thrust nozzle of the secondary flow channel. In the second case of an integral thrust nozzle, one thrust nozzle is provided for the primary flow channel and the secondary flow channel, with an internal jet intermixing taking place. This embodiment variant is also referred to as a “long cowl”.

The nozzle exit surface is that surface which is bordered by the trailing edge of the thrust nozzle. In the thrust nozzle of a secondary flow channel, it is ring-shaped. In an integral thrust nozzle, it is ring-shaped if a central body is present, or it is circular. If the angle of inclination equals zero (which does not correspond to the invention), the nozzle exit surface extends perpendicular to the center line of the thrust nozzle. In this case, a normal of the nozzle exit surface extends in parallel to the center line. If the angle of inclination is non-zero, corresponding to the present invention, the angle of inclination indicates the tilted position of the nozzle exit surface as compared to an arrangement perpendicular to the center line. Mathematically, this angle is identical with the angle that a normal vector of the nozzle exit surface forms with the center line of the thrust nozzle.

If the trailing edge of the thrust nozzle is not located in one plane, for example because the trailing edge is formed in a corrugated or curved manner, that surface is defined as the nozzle exit surface which contains the or an axially rearmost point of the trailing edge of the thrust nozzle as well as the or an axially frontmost point of the trailing edge of the thrust nozzle, with its normal vector being located in the vertical plane.

In general, the thrust nozzle of the turbofan engine can be configured in any desired manner, for example as a convergent thrust nozzle or as a convergent-divergent thrust nozzle, as an adjustable thrust nozzle or as non-adjustable thrust nozzle.

It is to be understood that the present invention is described with respect to a cylindrical coordinate system, having the coordinates x, r andφ. Here, x indicates the axial direction, r indicates the radial direction, and φ indicates the angle in the circumferential direction, with the axial direction being identical to the machine axis of the turbofan engine. Beginning at the x-axis, the radial direction points radially outward. Terms such as “in front”, “behind”, “frontal” and “rear” always refer to the axial direction or the flow direction inside the engine. Thus, the term “in front” means “upstream”, and the term “behind” means “downstream”. Terms such as “outer” or “inner” always refer to the radial direction. The vertical plane is that plane which contains the machine axis or x-axis and extends in the vertical direction (φ=0°). Terms such as “upper” or “lower” always refer to the vertical direction.

According to one embodiment of the invention, the articulation angle is in the range of less than 0° and equal to or greater than −4°, that is, in the half-open interval ]0, -4]. Here, a clockwise rotation is referred to as a mathematically negative direction of rotation in the customary mathematical annotation. The angle of inclination may for example be in the range of larger than 0° and equal to or smaller than 5°, that is, in the half-open interval ]0, 5]. The axial direction of the turbofan engine is the x-direction.

In a further embodiment of the invention, it is provided that, for forming the angle of inclination, a first trailing edge section of the thrust nozzle extends further in the longitudinal direction of the thrust nozzle than a diametrically opposite second trailing edge section of the thrust nozzle. Constructionally, the tilted position of the nozzle exit surface is thus achieved by a first area of the trailing edge being linearly extended in the longitudinal direction of the thrust nozzle and a diametrically opposite area being shortened in the longitudinal direction of the thrust nozzle based on a nominal orientation perpendicular to the machine axis. Of course, here the terms “elongation” and “shortening” do not refer to an actual elongation or shortening of an already manufactured part, but rather to conceptual measures for structurally arriving at a thrust nozzle with an angle of inclination based on a thrust nozzle without an angle of inclination.

Here, it can be provided that the trailing edge extends in a linear manner between the first trailing edge section and the second trailing edge section. Then, the trailing edge lies in one plane. Alternatively, it can be provided that the trailing edge extends in a curved or wavy manner between the first trailing edge section and the second trailing edge section. In that case, the trailing edge is located only approximately in one plane. As explained above, in this case that plane is regarded as the plane defining the angle of inclination which comprises the or an axially rearmost point of the trailing edge of the thrust nozzle as well as the or an axially frontmost point of the trailing edge of the thrust nozzle, with its normal vector being located in the vertical plane.

In one embodiment of the invention, the first trailing edge section of the thrust nozzle which extends further in the longitudinal direction of the thrust nozzle is formed at the bottom side of the thrust nozzle. Accordingly, the diametrically opposite second trailing edge section of the thrust nozzle is formed at the top side of the thrust nozzle.

In the invention, it is provided that the articulation angle is defined as that angle which the center line of the thrust nozzle forms with respect to the machine axis at least at the nozzle exit. This comprises embodiments in which the center line of the thrust nozzle is not a straight line but is curved, for example if the thrust nozzle is tilted with respect to the machine axis only towards the nozzle exit. In other embodiments, the center line of the thrust nozzle forms a straight line. According to one embodiment of the invention it is provided that the thrust nozzle is tilted with respect to the machine axis in its entirety or at least adjacent to the nozzle exit. For this purpose, it is provided in one embodiment variant that the thrust nozzle is tilted with respect to the machine axis by the articulation angle, wherein the rotational axis about which the thrust nozzle is rotated intersects the machine axis and extends perpendicular to the vertical plane.

A further embodiment of the invention relates to the ratio of the vertical distance h between the trailing edge of the wing flap and the machine axis to the axial distance L between the nozzle exit surface and the axial position of the trailing edge of the wing flap. According to one embodiment of the invention, this ratio is in the range between 0.2 and 1, with the ratio being regarded when the rear wing flap of the wing is fully extended.

A further embodiment of the invention relates to the ratio of the axial distance L between the nozzle exit surface and the axial position of the trailing edge of the wing flap to the diameter D of the nozzle exit surface. According to one embodiment of the invention, this ratio is between 2 and 3. Here again, the ratio is regarded when the rear wing flap of the wing is fully extended. If the nozzle exit surface is not circular-symmetrical, D indicates the larger diameter of the nozzle exit surface.

The invention further relates to a civilian or military aircraft with a turbofan engine according to claim 1 that is arranged below a wing of the airplane.

In the following, the invention is explained in more detail based on multiple exemplary embodiments by referring to the Figures of the drawing. Herein:

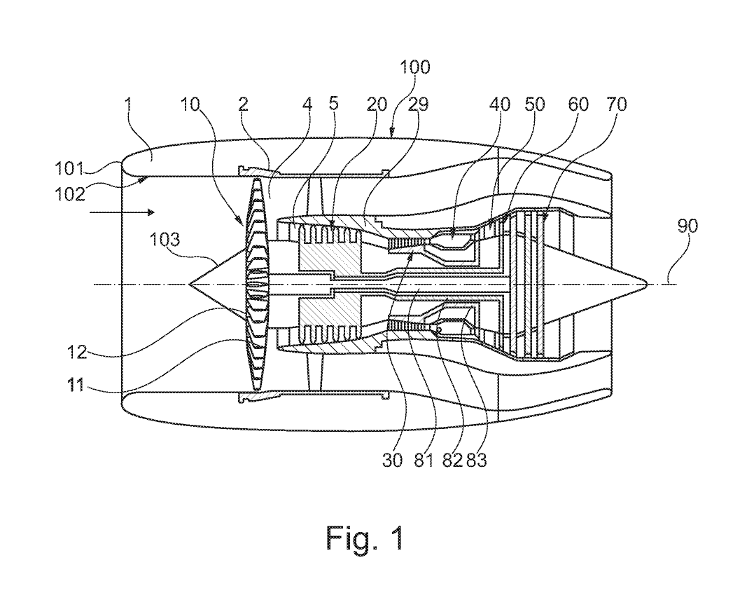

FIG. 1 shows a simplified schematic sectional view of a turbofan engine in which the present invention can be realized;

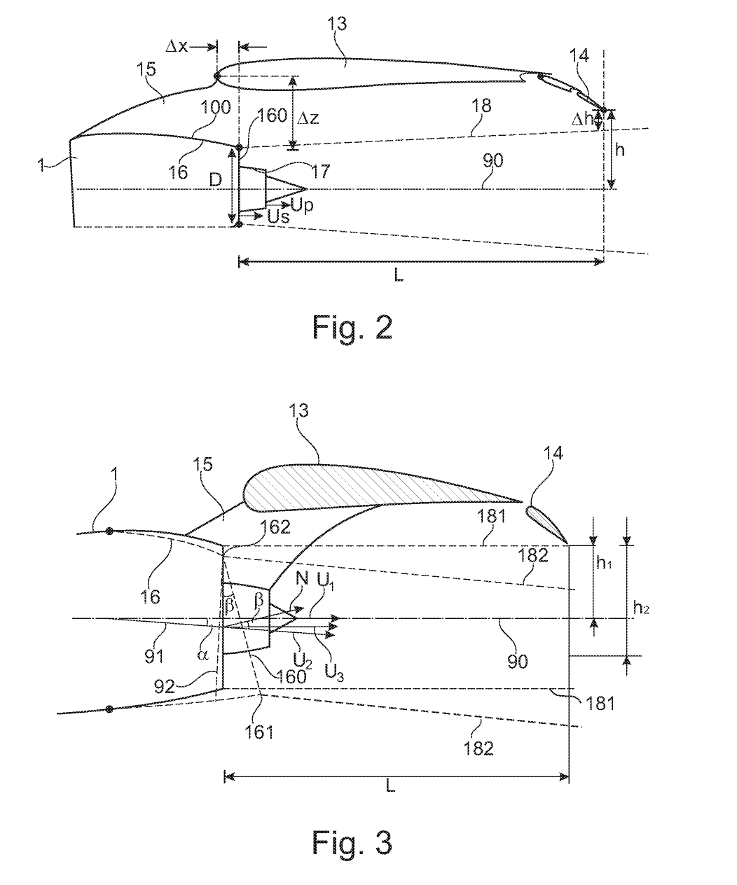

FIG. 2 shows, in a schematic manner, the installation of a turbofan engine below a wing, also showing relevant parameters;

FIG. 3 shows a turbofan engine that is installed below a wing, also rendering an angle of inclination and an articulation angle according to one embodiment of the present invention;

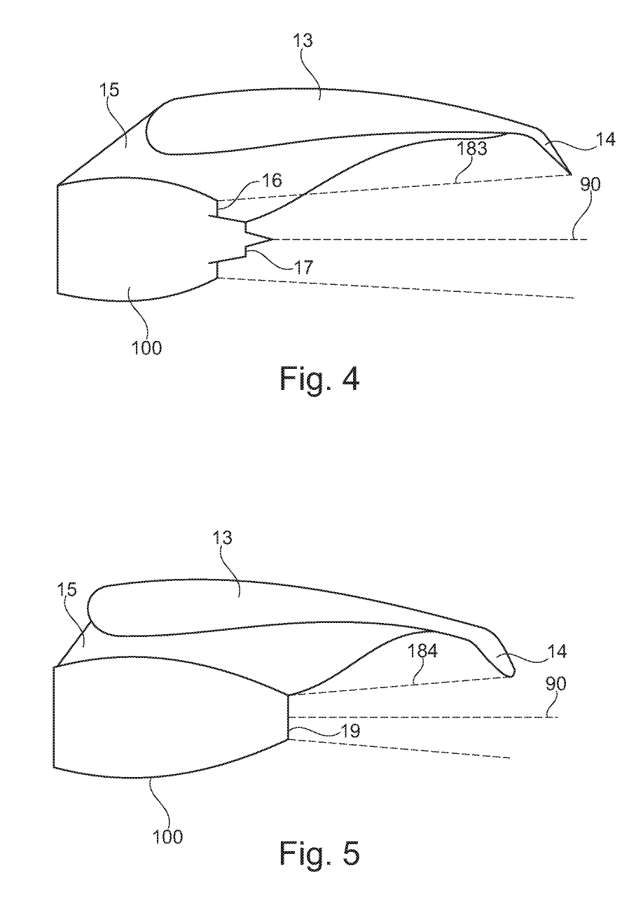

FIG. 4 shows, in a schematic manner, a turbofan engine that is installed below a wing and that comprises a separate thrust nozzle for the secondary flow channel;

FIG. 5 shows, in a schematic manner, a turbofan engine that is installed below a wing and that comprises an integral thrust nozzle;

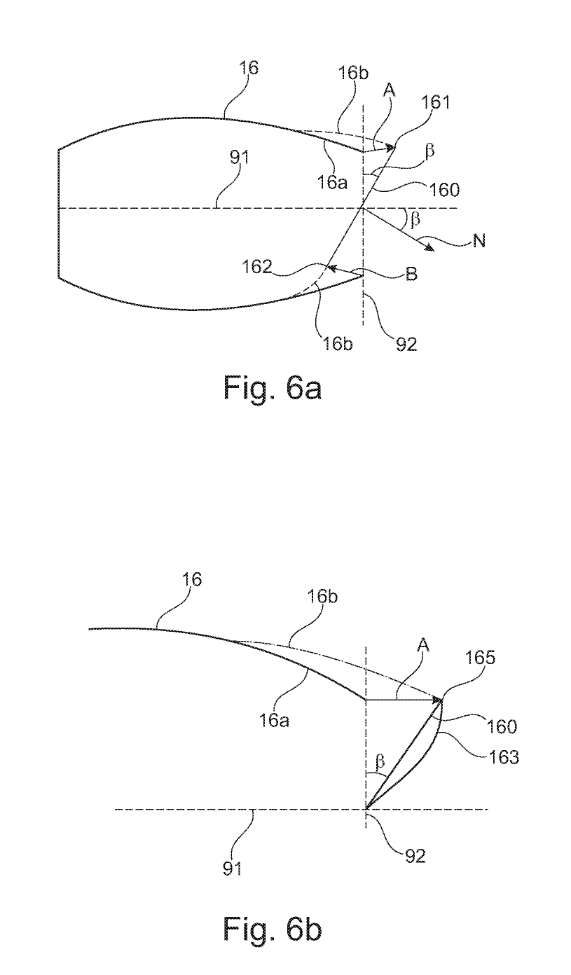

FIG. 6a shows, in a schematic manner, the transformation of a nominal thrust nozzle into a thrust nozzle that has an angle of inclination;

FIG. 6b shows a rendering corresponding to FIG. 6a in an enlarged view, wherein only one half of the thrust nozzle above the center line is shown;

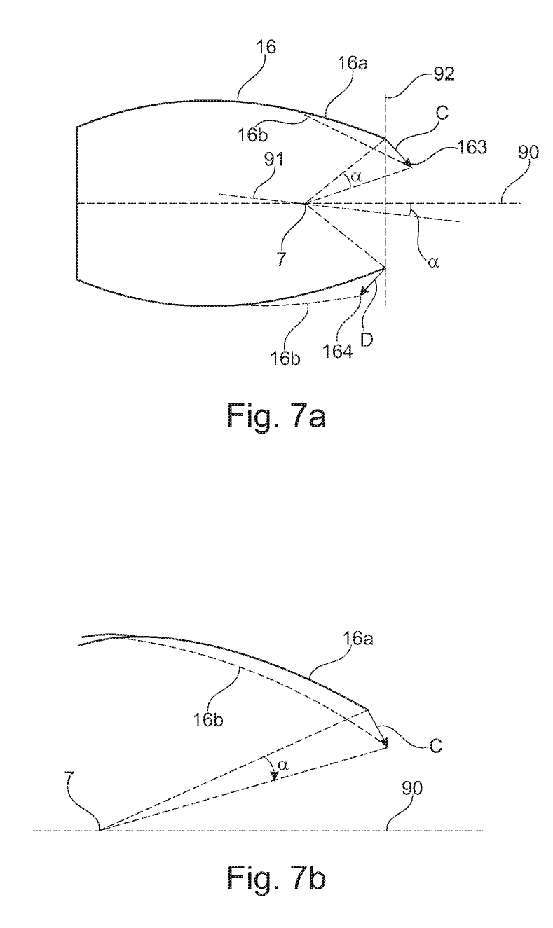

FIG. 7a shows, in a schematic manner, the transformation of a nominal thrust nozzle into a thrust nozzle that has an articulation angle;

FIG. 7b shows a rendering corresponding to the FIG. 7a in an enlarged view, wherein only one half of the thrust nozzle above the center line is shown;

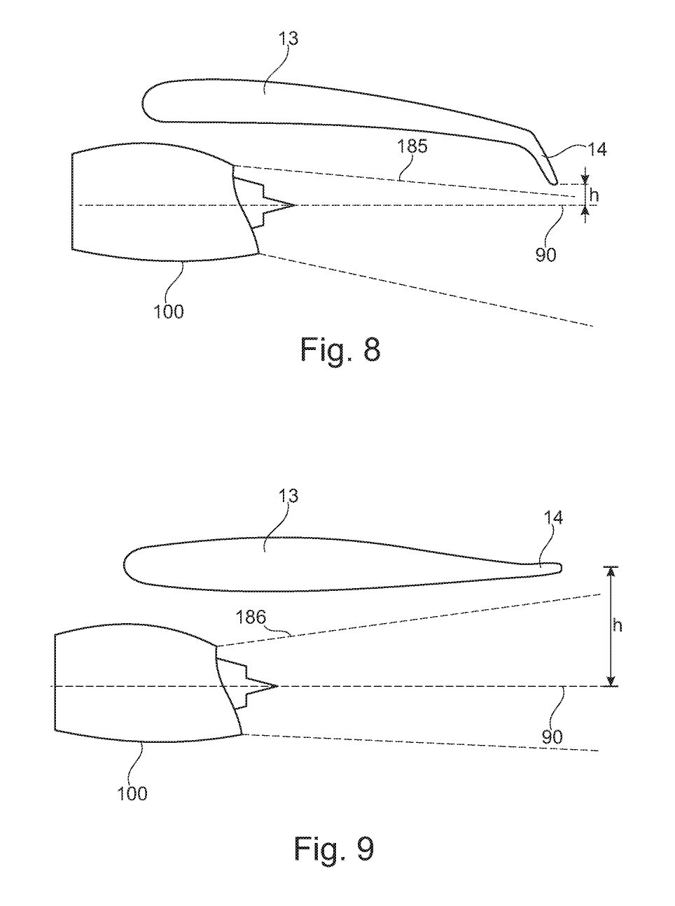

FIG. 8 shows, in a schematic manner, a turbofan engine installed below a wing, with its thrust nozzle being configured so as to form an articulation angle and an angle of inclination, also illustrating the exit jet and the wing flaps during takeoff;

FIG. 9 shows the turbofan engine of FIG. 8, also illustrating the exit jet and the wing flaps during cruise flight; and

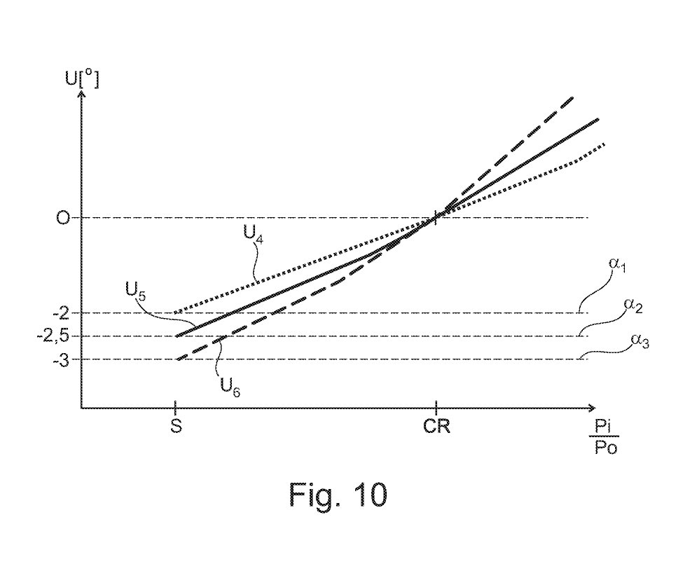

FIG. 10 shows a diagram that illustrates the deflection of the exit jet with respect to the machine axis for multiple articulation angles and angles of inclination as well as for different operational states of the turbofan engine.

FIG. 1 shows, in a schematic manner, a turbofan engine 100 having a fan stage with a fan 10 as the low-pressure compressor, a medium-pressure compressor 20, a high-pressure compressor 30, a combustion chamber 40, a high-pressure turbine 50, a medium-pressure turbine 60, and a low-pressure turbine 70.

The medium-pressure compressor 20 and the high-pressure compressor 30 respectively have a plurality of compressor stages that respectively comprise a rotor stage and a stator stage. The turbofan engine 100 of FIG. 1 further has three separate shafts, a low-pressure shaft 81 that connects the low-pressure turbine 70 to the fan 10, a medium-pressure shaft 82 that connects the medium-pressure turbine 60 to the medium-pressure compressor 20, and a high-pressure shaft 83 that connects the high-pressure turbine 50 to the high-pressure compressor 30. However, this is to be understood merely as an example. If, for example, the turbofan engine has no medium-pressure compressor and no medium-pressure turbine, only a low-pressure shaft and a high-pressure shaft would be present.

The turbofan engine 100 is arranged inside an engine nacelle 1. The latter is arranged below a wing, for example by means of a pylon. The engine nacelle 1 comprises an inlet lip 101 and forms an engine inlet 102 at the inner side, supplying inflowing air to the fan 10. The fan 10 has a plurality of fan blades 11 that are connected to a fan disk 12. Here, the annulus of the fan disk 12 forms the radially inner boundary of the flow path through the fan 10. Radially outside, the flow path is delimited by the fan housing 2. Upstream of the fan-disc 12, a nose cone 103 is arranged.

Behind the fan 10, the turbofan engine 100 forms a secondary flow channel 4 and a primary flow channel 5. The primary flow channel 5 leads through the core engine (gas turbine) which comprises the medium-pressure compressor 20, the high-pressure compressor 30, the combustion chamber 40, the high-pressure turbine 50, the medium-pressure turbine 60, and the low-pressure turbine 70. At that, the medium-pressure compressor 20 and the high-pressure compressor 30 are surrounded by a circumferential housing 29 which forms an annulus surface at the internal side, delimitating the primary flow channel 5 radially outside. Radially inside, the primary flow channel 5 is delimitated by corresponding rim surfaces of the rotors and stators of the respective compressor stages, or by the hub or elements of the corresponding drive shaft connected to the hub.

During operation of the turbofan engine 100, a primary flow flows through the primary flow channel 5, which is also referred to as the main flow channel. The secondary flow channel 4, which is also referred to as the partial-flow channel, bypass duct or bypass channel, guides air sucked in by the fan 10 during operation of the turbofan engine 100 past the core engine.

At the rear end, the turbofan engine forms a thrust nozzle. It can be provided that separate thrust nozzles are provided for the primary flow channel 5 and the secondary flow channel 4, or than an integral thrust nozzle is provided. In the latter case, the primary flow and the secondary flow are typically intermixed before they are being conducted into the integral thrust nozzle. The turbofan engine can further comprise an outlet cone so as to realize the desired cross sections of the flow channel.

The rotating components have a common rotational axis or machine axis 90. The rotational axis 90 defines an axial direction of the turbofan engine. A radial direction of the turbofan engine extends perpendicular to the axial direction.

What is significant in the context of the present invention is the embodiment of the thrust nozzle and the direction of the exit jet that is discharged by the thrust nozzle. For this purpose, it is provided in the invention that the thrust nozzle is configured so as to form an articulation angle and an angle of inclination.

FIG. 2 shows, in a schematic manner, the installation of a turbofan engine 100 at the bottom side of a wing 13. The engine nacelle 1 inside of which the turbofan engine is arranged is connected to the wing 13 by means of a pylon 15. At its downstream end, the wing 13 comprises wing flaps 14 that can be extended to a different extent depending on the fly mode. They represent lifting aids and are fully extended during takeoff. FIG. 2 shows the state during takeoff.

At its end, the turbofan engine forms a separate thrust nozzle 16 for the secondary flow channel and a separate thrust nozzle 17 for the primary flow channel. At its trailing edge, the thrust nozzle 16 forms a nozzle exit surface 160. The respectively exiting thrust vector is indicated by Us or Up. At that, the cold jet of the secondary flow channel envelops the hot jet of the primary flow channel. The jet provided by both components is referred to as the exit jet 18. Directly behind the turbofan engine, it has a cylindrical or slightly conical shape.

D indicates the largest diameter of the nozzle exit surface 160 of the thrust nozzle 16 for the secondary flow channel. Indicated by h is the vertical distance between the trailing edge of the wing flap 14 and the machine axis 90, or of the center line of the thrust nozzle 16. Indicated by Δh is the vertical distance between the trailing edge of the wing flap 14 and the boundary of the exit jet 18. L indicates the axial distance between the nozzle exit surface 160 and the axial position of the trailing edge of the wing flap 14.

For avoiding noise and for material protection, it is desirable that Δh is always higher than zero, i.e. that the exit jet 18 does not interact or interacts only insignificantly with the wing flaps 14. It can be difficult or impossible to meet this condition during takeoff, when the wing flaps 14 are completely extended, pointing obliquely downwards, as well as in the event that larger turbofan engines are used. Here, it has to be taken into account that the vertical distance Δz between the wing 13 and the turbofan engine 100 cannot be increased in any way desired, as a minimum distance to the ground must be ensured. Likewise, the possibility of keeping the exit jet 18 away from the wing flaps 14 by varying Δx is limited (cf. FIG. 2).

To solve this problem, it is provided in the invention that the outer thrust nozzle (or, if an integral thrust nozzle is used, the integral thrust nozzle) is arranged at an articulation angle and an angle of inclination, whereby the direction of the exit jet 18 is influenced. This is explained based on FIG. 3, in which the dashed line indicates the thrust nozzle 16 that is arranged at an articulation angle as well as an angle of inclination.

Compared to the conventional embodiment of a thrust nozzle according to FIG. 2, the thrust nozzle of FIG. 3 has undergone a twofold modification. For one thing, the thrust nozzle 16 is tilted with respect to the machine axis 90 while forming an articulation angle α that the center line 91 of the thrust nozzle 160 forms with respect to the machine axis 90, For another thing, the nozzle exit surface 160 of the thrust nozzle 16 is oriented obliquely while forming an angle of inclination β with respect to a plane 92 which is located perpendicularly on the center line 91 of the thrust nozzle 16. Here, the angle β is also the angle that a normal N of the nozzle exit surface 160 forms with respect to the center line 91 of the thrust nozzle 16.

Here, it is to be understood that a tilted position of the nozzle exit surface 160 is present with respect to the center line 91 of the thrust nozzle 16, and not with respect to the machine axis 90. For, a tilted position of the nozzle exit surface 160 with respect to the machine axis 90 already results from the tilting of the thrust nozzle 16 by the articulation angle a.

The tilted position of the nozzle exit surface 160 is achieved by virtue of a first lower trailing edge section 161 of the thrust nozzle 16 extending further into the axial direction than a diametrically opposite second upper trailing edge section 162 of the thrust nozzle 16. This will be explained in more detail with respect to FIGS. 6a and 6b.

Further, FIG. 3 shows different values U₁, U₂, U₃ for the thrust vector, different courses or directions of the exit jet 181, 182, and different values h₁, h₂ for the vertical distance between the trailing edge of the wing flap 14 and the center line of the thrust nozzle 16 (or of the exit jet 181, 182). These relationships are as follows.

The thrust vector U₁ and the exit jet 181 represent the situation without an articulation angle α and without an angle of inclination β of the thrust nozzle. In this case, the vertical distance between the trailing edge of the wing flap 14 and the center line of the thrust nozzle 16 or of the exit jet 181 is h₁.

If, by contrast, the thrust nozzle 16 is tilted by the articulation angle α and the normal vector N of its exit surface 160 is rotated with respect to the center line 91 of the thrust nozzle 16 by the angle of inclination β, the result is a thrust vector U₂, which substantially forms the angle α with respect to the central axis 90 during takeoff and is correspondingly oriented obliquely downwards. Thus, in this case the exit jet 182 is oriented more strongly downwards with respect to the exit jet 181, and has an enlarged vertical distance h₂ between the trailing edge of the wing flap 14 and the center line of the tilted thrust nozzle 16 or of the exit jet 182, so that the danger of an interaction with the wing flaps 14 is reduced. Correspondingly, the engine can be arranged at a smaller vertical distance to the wing 13, which is in particular necessary in engines with a larger diameter to ensure the necessary distance to the ground despite the large diameter of the engine.

Here, it is to be understood that the deflection of the exit jet was effected by the articulation angle α is independent of the operational state of the turbofan engine, in particular independent of the ratio between the nozzle internal pressure and the ambient pressure. In contrast to that, the deflection of the exit jet as effected by the angle of inclination β is dependent on the operational state of the turbofan engine due to physical reasons. This will be explained in more detail with respect to FIG. 10. Due to this dependence, the deflection caused by the angle of inclination β only starts taking effect at when the ratio between the nozzle internal pressure and the ambient pressure is larger.

In the embodiment variant shown in FIG. 3, the invention provides that the angle of inclination β and the articulation angle α have different mathematical signs, which, however, is not necessarily the case. Typical values for the angle of inclination β lie between 0° and 5°. Typical values for the articulation angle α lie between 0° and −4°, wherein the mathematical sign represents the direction of rotation with respect to the x-axis (that is, the machine axis) in the mathematical sense.

The following table indicates advantageous combinations of the angle of inclination β and the articulation angle α by way of example:

| angle of inclination β [°] | articulation angle α [°] |
|---|---|
| 1.5 | −2 |
| 2.5 | −3 |
| 4 | −4 |

Since the deflection caused by the angle of inclination β only takes effect at a higher ratio between the nozzle internal pressure and the ambient pressure, it is the deflection caused by the articulation angle α that dominates during takeoff, so that the exit jet is deflected obliquely downwards.

By contrast, the angle of inclination is positive. As the pressure ratio between the nozzle internal pressure and the ambient pressure increases, the effect of the jet deflection caused by the angle of inclination becomes increasingly stronger. At that, the jet deflection caused by the angle of inclination β acts in another direction, i.e. the deflection of the exit jet as caused by the angle of inclination β occurs upwards, with this effect getting stronger as the pressure ratio between the nozzle internal pressure and the ambient pressure increases. FIG. 3 shows, in a schematic manner and by way of example, the thrust vector U₃ that occurs due to the overlapping of the described effects during cruise flight. Here, the thrust vector U₃ extends substantially in parallel to the thrust vector U₁ which represents the situation without an articulation angle α and without an angle of inclination β of the thrust nozzle.

As for the parameters h, L and D explained with respect to FIG. 2, it applies to a thrust nozzle with an articulation angle and an angle of inclination according to an exemplary embodiment that, with respect to the fully extended rear wing flap 14, the ratio of the vertical distance h between the trailing edge of the wing flap and the machine axis to the axial distance L between the nozzle exit surface and the axial position of the trailing edge of the wing flap 14 is in the range of between 0.2 and 1. The ratio of the axial distance L between the nozzle exit surface and the axial position of the trailing edge of the wing flap 14 to the diameter D of the nozzle exit surface my for example be in the range of between 2 and 3.

FIGS. 4 and 5 illustrate that the thrust nozzle, which is configured according to the invention so as to form an articulation angle and an angle of inclination, can be a separate thrust nozzle of a secondary flow channel or an integral thrust nozzle. Thus, FIG. 4 schematically shows the arrangement of a turbofan engine 100 below a wing 13 by means of a pylon 15, wherein the turbofan engine according to FIG. 2 has a separate thrust nozzle 16 for the secondary flow channel and a separate thrust nozzle 17 for the primary flow channel. The exit jet is indicated by 183. In the exemplary embodiment of FIG. 5, an integral thrust nozzle 19 is provided, wherein the primary flow and the secondary flow are intermixed before entering the integral thrust nozzle. The exit jet is indicated by 184.

FIGS. 6a and 6b illustrate the structural modification that a nominal thrust nozzle 16 is submitted to for realizing an angle of inclination. What is referred to as the nominal thrust nozzle here is a thrust nozzle that has a nozzle exit surface that lies in a plane 92 that extends perpendicular to the center line 91 of the thrust nozzle 16.

Here, the solid line 16a shows the nominal thrust nozzle. The trailing edge of the thrust nozzle lies in the plane 92 and defines the nozzle exit surface. Based on such a nominal thrust nozzle, the thrust nozzle provided with an angle of inclination is obtained by means of two linear displacements. Thus, a first area of the thrust nozzle is extended in the longitudinal direction of the center line 91 corresponding to arrow A. At the same time, a diametrically opposite second area of the thrust nozzle is shortened counter to the longitudinal direction of the center line 91 in the linear direction corresponding to arrow B. In this manner, it is achieved that a first trailing edge section 161 of the thrust nozzle 16 extends further in the axial direction than a diametrically opposite second trailing edge section 162 of the thrust nozzle 16. The angle β with respect to the plane 92 is the angle of inclination. It is identical with the angle between the normal vector N and the center line 91. The inner contour of the thrust nozzle is modified corresponding to the dashed line 16b. Thus, the thrust nozzle provided with an angle of inclination results from two linear constructional elongations or shortenings that occur in opposite directions.

FIG. 6b corresponds to FIG. 6a, wherein only the area above the center line 91 is shown. The explanations relating to FIG. 6a apply correspondingly. However, it is additionally shown by way of example that the trailing edge 165 of the thrust nozzle 16 does not necessarily extend in a linear manner, as shown in FIG. 6a. Thus, it can alternatively be provided that the trailing edge 165 is corrugated, or that it is curved in a different manner. A corresponding alternative trailing edge shape is indicated by line 163. In such a case, that surface is defined as the nozzle exit surface 160 which has the axially rearmost point 161 of the trailing edge of the thrust nozzle and the axially frontmost point 162 of the trailing edge of the thrust nozzle, with its normal vector being located in the vertical plane (that corresponds to the drawing plane), cf. FIG. 6a.

On this occasion, it is pointed out that the terms “normal vector” and “normal” are used synonymously in the present description. In fact, a straight line that has the normal vector as the direction vector is referred to as the normal.

FIGS. 7a and 7b illustrate the structural modification that a nominal thrust nozzle 16 is subjected to for realizing an articulation angle a. What is referred to as the nominal thrust nozzle is a thrust nozzle having a central axis that is located on the machine axis 90 of the turbofan engine.

Here, the solid line 16a shows the nominal thrust nozzle. The central axis of the thrust nozzle 16 is located on the machine axis 90 of the turbofan engine. The trailing edge is located in the plane 92. Based on such a nominal thrust nozzle, the thrust nozzle provided with an articulation angle is obtained by means of a rotation about a rotational axis 7 that intersects with the machine axis 90 of the turbofan engine and extends perpendicular to the vertical plane. The rotation by the angle α occurs in the clockwise direction, i.e. with a negative mathematical angle. Here, the trailing edge is also turned in the shown sectional view, which leads to the displacements of the trailing edge as indicated by arrows C and D. The inner contour of the thrust nozzle 16 is modified corresponding to the dashed line 16b. After the rotation, the center line 91 of the thrust nozzle is no longer identical with the machine axis 90, but is rotated by an angle α with respect to the machine axis 91.

It is to be understood that, as a result of the rotation of the thrust nozzle 16, it is also achieved that an area 163 of the trailing edge has a more downstream axial position than a diametrically opposite area 164 of the trailing edge. However, this should not be confused with the angle of inclination, as the latter refers to a rotation with respect to the center line of the thrust nozzle. With respect to the center line of the thrust nozzle, the rotation about the rotational axis 7 does not lead to a tilted position of the nozzle exit surface.

FIG. 7b shows the performed rotation of the thrust nozzle in an enlarged rendering. The explanations relating to FIG. 7a apply correspondingly.

FIGS. 8 and 9 illustrate the dependence of the deflection of the exit jet, as it results in total from the provision of an articulation angle and an angle of inclination, on the operating mode. FIG. 8 shows the take-off thrust when the wing flaps 14 are maximally extended. The exit jet 185 is deflected obliquely downwards, so that an interaction with the wing flaps 14 is avoided. FIG. 9 shows the cruise flight thrust. The effect provided by the angle of inclination now substantially cancels out the effect provided by the articulation angle, so that the exit jet 186 is emitted substantially in the axial direction, without a substantial vertical downwards component. Since the wing flaps 14 are retracted, this is unproblematic.

FIG. 10 further illustrates the explained dependence of the resulting deflection of the exit jet on the operating mode. Here, the x-axis indicates the quotient between the nozzle internal pressure pᵢ and the ambient pressure p₀. The y-axis indicates the direction of the resulting thrust vector of the exit jet, with the deviation with respect to the x-axis being indicated in degrees. The total deflection U, which is shown for three examples U₄, U₅, U₆, is the sum of the deflections based on the articulation angle α and the deflections based on the angle of inclination β. For that, different values are given by way of example. During take-off thrust S, it is substantially only the jet deflection resulting from the articulation angle α that takes effect. As the pressure ratio pᵢ/p₀ becomes higher, the share of the deflection of the exit jet resulting from the angle of inclination increases. During cruise flight thrust CR, both effects substantially cancel each other out. With even higher pressure ratios, the share of the jet deflection caused by the angle of inclination predominates.

The present invention is not limited in its embodiment to the previously described exemplary embodiments, which are to be understood merely as examples. In particular, the shown thrust nozzles are only shown in a schematic manner.

Further, it is to be understood that the features of the individual described exemplary embodiments of the invention can be combined with each other into different combinations. As far as ranges are defined, they comprise all values within these ranges, as well as all partial ranges falling within a range.

1. A turbofan engine that is provided and suitable for the purpose of being arranged below a wing of an airplane, wherein the turbofan engine comprises:
a core engine that comprises a compressor, a combustion chamber and a turbine,
a primary flow channel that leads through the core engine,
a secondary flow channel that leads past the core engine,
a machine axis of the core engine,
a thrust nozzle which has a separate thrust nozzle for the secondary flow channel, or is an integral thrust nozzle for the primary flow channel and the secondary flow channel, and which comprises:
a center line,
a nozzle exit surface,
wherein
the thrust nozzle is tilted with respect to the machine axis while forming a articulation angle that the center line of the thrust nozzle forms with respect to the machine axis at least at the nozzle exit, and that the nozzle exit surface of the thrust nozzle is obliquely oriented with respect to the center line of the thrust nozzle while forming an angle of inclination that a normal of the nozzle exit surface forms with respect to the center line of the thrust nozzle.

2. The turbofan engine according to claim 1, wherein the articulation angle and the angle of inclination have different mathematical signs.

3. The turbofan engine according to claim 2, wherein the articulation angle is negative, wherein the center line of the thrust nozzle is tilted downwards with respect to the machine axis.

4. The turbofan engine according to claim 2, wherein the angle of inclination is positive, wherein the normal of the nozzle exit surface is tilted upwards with respect to the center line of the thrust nozzle.

5. The turbofan engine according to claim 1, wherein the articulation angle is in the range of less than 0° and equal to or greater than −4°.

6. The turbofan engine according to claim 1, wherein the angle of inclination is in the range of larger than 0° and equal to or smaller than 5°.

7. The turbofan engine according to claim 1, wherein, for the purpose of forming the angle of inclination, a first trailing edge section of the thrust nozzle extends further in the longitudinal direction of the thrust nozzle than a diametrically opposite second trailing edge section of the thrust nozzle.

8. The turbofan engine according to claim 7, wherein the trailing edge extends in a linear manner between the first trailing edge section and the second trailing edge section.

9. The turbofan engine according to claim 7, wherein the trailing edge extends in a curved or corrugated manner between the first trailing edge section and the second trailing edge section.

10. The turbofan engine according to claim 7, wherein the first trailing edge section of the thrust nozzle that extends further in the longitudinal direction of the thrust nozzle is formed at the bottom side of the thrust nozzle, and that the diametrically opposite second trailing edge section of the thrust nozzle is formed at the top side of the thrust nozzle.

11. The turbofan engine according to claim 1, wherein the thrust nozzle is tilted by the articulation angle with respect to the machine axis, wherein the rotational axis about which the thrust nozzle is tilted intersects with the machine axis and extends perpendicular to the vertical plane.

12. The turbofan engine according to claim 1, wherein, with respect to the fully extended rear wing flap of the wing below which the turbofan engine is arranged, the ratio of the vertical distance between the trailing edge of the wing flap and the machine axis to the axial distance between the nozzle exit surface and the axial position of the trailing edge of the wing flap is in the range of between 0.2 and 1.

13. The turbofan engine according to claim 1, wherein, with respect to the fully extended rear wing flap of the wing below which the turbofan engine is arranged, the ratio of the axial distance between the nozzle exit surface and the axial position of the trailing edge of the wing flap to the diameter of the nozzle exit surface is in the range of between 2 and 3.

14. The turbofan engine that is provided and suitable for the purpose of being arranged below a wing of an airplane, wherein the turbofan engine comprises:
a core engine that comprises a compressor, a combustion chamber and a turbine,
a primary flow channel that leads through the core engine,
a secondary flow channel that leads past the core engine,
a machine axis of the core engine,
a thrust nozzle which is a separate thrust nozzle for the secondary flow channel, or an integral thrust nozzle for the primary flow channel and the secondary flow channel, and which comprises:
a center line,
a nozzle exit surface,
wherein
the thrust nozzle is tilted downwards with respect to the machine axis while forming an articulation angle that the center line of the thrust nozzle forms with respect to the machine axis at least at the nozzle exit, and the nozzle exit surface of the thrust nozzle is oriented obliquely upwards while forming an angle of inclination that a normal of the nozzle exit surface forms with respect to the center line of the thrust nozzle.

15. An airplane with a turbofan engine according to claim 1 that is arranged below a wing of the airplane.
